(19) United States
(12) Patent Application Publication
(10) Pub. No.: US 2022/0408373 A1
(43) Pub. Date: Dec. 22, 2022

(54) DEVICES FOR POWER CONTROL FOR SIDELINK FEEDBACK

(71) Applicant: HUAWEI TECHNOLOGIES CO., LTD., Shenzhen (CN)

(72) Inventors: Mario Hernán CASTAÑEDA GARCIA, Munich (DE); Richard STIRLING-GALLACHER, Munich (DE)

(21) Appl. No.: 17/896,189

(22) Filed: Aug. 26, 2022

Related U.S. Application Data
(63) Continuation of application No. PCT/EP2020/055255, filed on Feb. 28, 2020.

(51) Int. Cl. H04W 52/32; H04W 52/38; H04W 52/24; H04W 72/04

(52) U.S. Cl. CPC H04W 52/325; H04W 52/383; H04W 52/242; H04W 72/0406

(57) ABSTRACT

A first user equipment (UE) is configured to perform power control for a sidelink (SL) feedback. The first UE is configured to select a communication resource for sending a feedback message over a SL to a second UE, and select a power level for sending the feedback message. The power level is selected based on the communication resource.

### CROSS-REFERENCE TO RELATED APPLICATIONS

This application is a continuation of International Application No. PCT/EP2020/055255, filed on Feb. 28, 2020, the disclosure of which is hereby incorporated by reference in its entirety.

### TECHNICAL FIELD

The present disclosure relates to devices in a mobile network, which communicate over a sidelink (SL), in particular User Equipment (UE). The mobile network may comprise a 5^{th} generation mobile or cellular communication (5G) system (5GS) or network. In particular, the disclosure is concerned with power control for a SL feedback, i.e., Physical SL Feedback Channel (PSFCH) power control, e.g., for New Radio (NR) Vehicle-to-Anything (V2X). To this end, the disclosure proposes a first UE for performing the power control, provides a second UE for supporting the power control, and provides corresponding methods.

### BACKGROUND

A SL feedback is a feedback in the SL (between UEs) to a unicast transmission or a groupcast transmission. A unicast transmission is a transmission from a transmit UE (Tx UE) to a receive UE (Rx UE), and a groupcast transmission is a transmission from a Tx UE to a group of Rx UEs. In this disclosure, the Tx UE is referred to as the Source UE (or also the “second UE”), and the Rx UE is referred to as the Target UE (or also the “first UE”). For the SL feedback, to both a unicast or groupcast transmission, the roles of the UEs are reversed: i.e., a Target UE becomes the transmitter of the SL feedback, and the Source UE becomes the receiver of the SL feedback—as it is shown in FIG. 1.

For both unicast and groupcast transmissions, a feedback from the Target UE(s) to the Source UE can be performed for several purposes, e.g. including:
Hybrid Automatic Repeat Request (HARQ) feedback: The Target UE(s) may send a Negative Acknowledgement (NACK) and/or may send an Acknowledgment (ACK) to the Source UE.
Feedback for a power control of the Physical Sidelink Control Channel (PSCCH) and/or for the Physical Sidelink Shared Channel (PSSCH): The Target UE(s) may send to the Source UE a SL reference signal received power (SL-RSRP), or may send to the Source UE information about the SL-RSRP for SL pathloss derivation at the Source UE (e.g., a SL-RSRP report). The SL-RSRP may also be referred to as RSRP.
Feedback for channel state information (CSI) reporting for a SL transmission: The Target UE(s) may send to the Source UE a CSI report comprising a channel quality indicator (CQI), a rank indicator (RI) or a precoding matrix indicator (PMI).
The SL feedback, SL feedback link or SL feedback channel may also be referred to as PSFCH.

### SUMMARY

Embodiments of the invention base also on the following considerations made by the inventors.

Similar to the PSCCH/PSSCH power control performed at the Source UE, a PSFCH power control at a Target UE could be based on a downlink (DL) pathloss (Uu pathloss) from a gNB (generally from the “network” or “base station”) to the Target UE, when the Target UE is in coverage of the network (i.e., the gNB is the serving gNB of the Target UE). Additionally or alternatively, the PSFCH power control could be based on a SL pathloss between the Source UE and the Target UE. In this disclosure, the DL pathloss is referred to as the pathloss from the gNB to the Target UE, and the SL pathloss is referred to as the pathloss between the Source UE and the Target UE, unless stated otherwise.

The DL pathloss could be considered for the PSFCH power control, in order to mitigate any interference to the gNB. Considering the SL pathloss for the PSFCH power control could avoid that the Target UE transmits at a higher power than necessary, e.g., in the case that the SL pathloss is much smaller than the DL pathloss—as shown exemplarily for unicast in FIG. 2.

In addition, considering the SL pathloss could enable having at the Source UE (i.e., the UE receiving the feedback) the same (or at least similar) received power for several Target UEs, e.g. for a groupcast feedback, which may alleviate the effect of the near-far issue as well in-band emissions, when the Target UEs of a groupcast transmission have distinct SL pathlosses. This is exemplarily depicted in FIG. 3. The near-far issue and the in-band emissions may result, when the Target UEs send the feedback with Code Division Multiplexing (CDM) and with Frequency Division Multiplexing (FDM), respectively.

However, to enable a PSFCH power control based on the SL pathloss, a Target UE would need to determine the SL pathloss from the Target UE to the Source UE. In order for each Target UE to obtain the SL pathloss to the Source UE, additional signaling would be required, e.g., for the Source UE to indicate the transmit power used by the Source UE for sending a reference signal, or to indicate the SL pathloss to each Target UE, which was derived at the Source UE. This would come at the expense of overhead, or may not always be feasible.

Therefore, it was proposed for Rel. 16 NR V2X that PFSCH power control at the Target UE (when the Target UE is in coverage) could be based on the DL pathloss from the gNB to the Target UE, but it should not be based on the SL pathloss between the Source UE and the Target UE. Thus, such PFSCH power control disadvantageously does not have the benefits that result when considering the SL pathloss. That is, the Target UE(s) may transmit at a higher power than necessary.

In view of the above, embodiments of the present invention aim to provide an improved SL feedback power control (PFSCH power control). An objective is to provide a more power efficient SL feedback power control. Thereby, the Source UE should be able to determine a certain SL feedback power control for one or more Target UE(s). Further, it should be possible to take into account, for the SL feedback power control, additional feedback characteristics and/or parameters, for example including the SL pathloss.

The objective is achieved by the embodiments of the invention as described in the enclosed independent claims. Advantageous implementations of the embodiments of the invention are further defined in the dependent claims.

A first aspect of this disclosure provides a first UE, for performing power control for a SL feedback, the first UE being configured to: select a communication resource for sending a feedback message over a SL to a second UE; and select a power level for sending the feedback massage, wherein the power level is selected based on the communication resource.

Accordingly, the first UE may configure the PSFCH power control (i.e., the power control of the first UE for the feedback in the SL) depending on the communication resource, in which the first UE sends the feedback message. Thus, the PSFCH power control may be configured per communication resource or PSFCH, wherein one or more communication resources or feedback channels (PSFCHs) may be configured for the feedback.

The first UE can provide a more power efficient SL feedback power control. In particular, it can be avoided that the first UE feeds back with too much power. It is possible that the first UE is configured by the second UE, i.e., the second UE may be able to determine a SL feedback power control for the first UE, based on the communication resource used by the first UE for the feedback. Further, it is possible that the SL feedback power control at the first UE takes into account additional feedback characteristics and/or parameters for the power control, for example, the SL pathloss or interference associated with the communication resource.

The communication resource may also be referred to as a “feedback resource” or a “PSFCH resource”, or “PSFCH communication resource”, and may comprise a time resource, and/or frequency resource, and/or code resource, and/or spatial resource, which is selected or configured for sending the SL feedback (message). The first UE is also referred to as “Target UE”. The second UE is also referred to as “Source UE”.

In an implementation form of the first aspect, the first UE is configured to: select the power level based further on a type and/or a content of the feedback message.

Thus, an even more power efficient power control is enabled, for instance, because less or more power can be used for certain types and/or contents of the feedback message.

In an implementation form of the first aspect, a type of the feedback message comprises at least one of: a HARQ, feedback; a RSRP report; a CSI report.

In an implementation form of the first aspect, a content of the feedback message comprises at least one of: an ACK feedback; a NACK feedback; a NACK-only feedback; a feedback for PSCCH; a feedback for PSSCH.

The feedback for PSCCH and/or PSSCH may, in particular, be a feedback for PSCCH/PSSCH power control.

In an implementation form of the first aspect, the first UE is further configured to: select the power level based further on one or more pathlosses, wherein one or more pathlosses comprise at least one of: a SL pathloss between the first UE and the second UE; a DL pathloss between the first UE and a base station serving the first UE; a pathloss between the first UE and a third UE; a pathloss between the first UE and another base station.

Thus, a power efficient control of the feedback is enabled, while guaranteeing reliability of the feedback and/or minimizing interference to other devices or links.

A base station can refer to a network device, an evolved NodeB (eNB), a NodeB, a next generation NodeB (gNB), a master eNB (MeNB), a secondary eNB (SeNB), a remote radio head, an access point, a transmit-receive point (TRP) or the like.

In an implementation form of the first aspect, the first UE is further configured to: determine the power level based further on whether the feedback message is for unicast feedback or groupcast feedback.

In an implementation form of the first aspect, the first UE is further configured to: select the communication resource from a resource set.

The resource set may be preconfigured, or may be configured by the second UE, or may be dynamically adjusted or determined at the first UE, i.e. determined based on the resources used by a transmission from the second UE to the first UE. The resource set may be shared by two or more first UEs, but may also be an individual resource set for the first UE.

In an implementation form of the first aspect, the resource set is assigned to the first UE by the second UE or by a base station serving the first UE.

In an implementation form of the first aspect, the first UE is further configured to select the communication resource based on at least one of: a distance between the first UE and the second UE; a SL pathloss between the first UE and the second UE; a RSRP at the first UE; an identifier of the first UE; an identifier of the second UE.

Thus, an even more power efficient control of the feedback is enabled.

In an implementation form of the first aspect, the first UE is further configured to: receive a configuration or a configuration update message, wherein the configuration or configuration update message indicates at least one association between a communication resource and a power control configuration.

The power control configuration may refer to a configuration (or specification), as to how the power level is selected by the first UE, which can be based on one or more pathloss(es) and one or more power control parameter(s). That is, the first UE can base its selection of the power level on the configuration or updated configuration.

In an implementation form of the first aspect, the first UE is further configured to select the power level based at least on one of the following: a maximum power level; a fixed power level; one or more nominal power levels, each nominal power level being associated with a certain pathloss used by the first UE to select the power level; one or more factors used for fractional power control, each factor being associated with a certain pathloss used by the first UE to select the power level.

In an implementation form of the first aspect, the communication resource comprises a time resource, and/or a frequency resource, and/or a spatial resource, and/or a code resource.

A second aspect of this disclosure provides a second UE for supporting power control for SL feedback, the second UE being configured to: provide a configuration message to a first UE, wherein the configuration message indicates at least one association between a communication resource and a power control configuration.

In an implementation form of the second aspect, the second UE is further configured to: receive a feedback message on a communication resource from the first UE; determine an interference at the second UE on the communication resource; and provide, based on the determined interference, a configuration update message to the first UE, wherein the configuration update message indicates at least one updated association between a communication resource and a power control configuration.

By sending the configuration message or configuration update message, the second UE can support the power control of the SL feedback performed at the first UE. The first UE may select the power level for sending the SL feedback based on the configuration message or configuration update message, e.g., according to the association or updated association to the selected communication resource.

In an implementation form of the second aspect, the second UE is further configured to: provide the configuration and/or or the configuration update message as groupcast message to a plurality of first UEs.

A third aspect of this disclosure provides a method for performing power control for SL feedback, the method comprising: selecting a communication resource for sending a feedback message over a SL; and selecting a power level for sending the feedback massage, wherein the power level is selected based on the communication resource.

In an implementation form of the third aspect, the method comprises: selecting the power level based further on a type and/or a content of the feedback message.

In an implementation form of the third aspect, a type of the feedback message comprises at least one of: a HARQ, feedback; a RSRP report; a Channel State Information (CSI) report.

In an implementation form of the third aspect, a content of the feedback message comprises at least one of: an ACK feedback; a NACK feedback; a NACK-only feedback; a feedback for PSCCH; a feedback for PSSCH.

In an implementation form of the third aspect, the method further comprises: selecting the power level based further on one or more pathlosses, wherein one or more pathlosses comprise at least one of: a SL pathloss between a first UE and a second UE; a DL pathloss between a first UE and a base station serving the first UE; a pathloss between a first UE and a third UE; a pathloss between a first UE and another base station.

The first UE may in particular perform the method of the third aspect.

In an implementation form of the third aspect, the method further comprises: determining the power level based further on whether the feedback message is for unicast feedback or groupcast feedback.

In an implementation form of the third aspect, the method further comprises: selecting the communication resource from a resource set.

In an implementation form of the third aspect, the resource set is assigned by a UE or by a base station.

In an implementation form of the third aspect, the method comprises selecting the communication resource based on at least one of: a distance between a first UE and a second UE; a SL pathloss between a first UE and a second UE; a RSRP at a first UE; an identifier of the first UE; an identifier of the second UE.

The first UE may in particular perform the method of the third aspect.

In an implementation form of the third aspect, the method further comprises: receiving a configuration or a configuration update message, wherein the configuration or configuration update message indicates at least one association between a communication resource and a power control configuration.

In an implementation form of the third aspect, the method further comprises selecting the power level based at least on one of the following: a maximum power level; a fixed power level; one or more nominal power levels, each nominal power level being associated with a certain pathloss used to select the power level; one or more factors used for fractional power control, each factor being associated with a certain pathloss used to select the power level.

In an implementation form of the third aspect, the communication resource comprises a time resource, and/or a frequency resource, and/or a spatial resource, and/or a code resource.

The method of the third aspect and its implementation forms achieve the same advantages as the device of the first aspect and its respective implementation forms.

A fourth aspect of this disclosure provides a method for supporting power control for SL feedback, the method comprising: providing a configuration message, wherein the configuration message indicates at least one association between a communication resource and a power control configuration.

In an implementation form of the fourth aspect, the method further comprises: receiving a feedback message on a communication resource; determining an interference on the communication resource; and providing, based on the determined interference, a configuration update message, wherein the configuration update message indicates at least one updated association between a communication resource and a power control configuration.

In an implementation form of the fourth aspect, the method comprises: providing the configuration and/or or the configuration update message as groupcast message.

The method of the fourth aspect and its implementation forms achieve the same advantages as the device of the second aspect and its respective implementation forms.

A fifth aspect of this disclosure provides a computer program comprising a program code for performing the method according to the third aspect, the fourth aspect, or any implementation form thereof, when executed on a computer.

A sixth aspect of this disclosure provides a non-transitory storage medium storing executable program code which, when executed by a processor, causes the method according to the third aspect, the fourth aspect, or any implementation form thereof to be performed.

In summary, for the PSFCH power control at a first UE (Target UE), a PSFCH power control configuration depending on the communication resource is provided, i.e. on the PSFCH resource, used by the first UE to send the feedback message. The communication resource may be selected from a set of resources assigned by the second UE (Source UE), or by the network; and/or it may be selected by the first UE (e.g. depending on the Tx-Rx distance, SL-RSRP, SL pathloss of the first UE an identifier of the first UE or an identifier of the second UE).

In addition, as different types of feedback types (messages) and contents may be fed back in different communication resources, the PSFCH power control may also depend on the content and/or type of feedback message, which the first UE is sending to the second UE, e.g., depending on whether the first UE is sending HARQ feedback, i.e. a NACK or ACK feedback; or depending on whether the first UE is sending feedback for PSCCH/PSSCH power control (i.e. SL-RSRP report); or depending on whether the first UE is sending another type of feedback (e.g. a CSI report).

The content of the PSFCH (feedback) power control may be based on the DL pathloss and/or the SL pathloss, as well as it may be based on any other pathloss, e.g. a pathloss from the first UE to other UEs, or a pathloss from the first UE to other gNBs.

In addition, the content of the PSFCH (feedback) power control may include the following example parameters for the PSFCH power control:
A maximum transmit power P_{MAX};
A nominal power P₀, for each of the pathloss on which the PSFCH power control is based;
A factor α (i.e. parameter used for fractional power control), for each of the pathlosses on which the PSFCH power control is based; and/or
A fixed transmit power P_{Fixed} to be used by a first UE, i.e. if it does not exceed the maximum transmit power.

The configuration of the PSFCH power control may be preconfigured (e.g. for out-of-coverage) or configured by the gNB, or by the second UE. The configuration of the PSFCH power control per communication resource can be signaled by the second UE or the gNB (network) in a groupcast way, i.e. signaled to a group of first UEs. Furthermore, the second UE can adapt/update the configuration of the PSFCH power control depending on the interference at the second UE on that PSFCH communication resource. This interference can result from other transmissions to the second UE or from transmissions to other devices.

Moreover, the PSFCH communication resource, on which the first UE sends the feedback message, can be selected from a PSFCH resource or a set of PSFCH resources assigned by the second UE or the gNB, and/or can be selected by the first UE depending on the Tx-Rx distance, SL-RSRP, the SL pathloss of the first UE, an identifier of the first UE or an identifier of the second UE.

Some additional definitions and information is provided in the following.

Feedback may generally be sent on a time resource, and/or frequency resource, and/or code, and/or spatial resource. For instance, it may be sent via CDM and/or via FDM.

For unicast, dedicated (separate) PSFCH communication resource(s) may be used by the first UE(s) to send the feedback message. For instance, a first UE may send HARQ feedback message (i.e. ACK or NACK) in a dedicated PSFCH resource(s), e.g. a first UE may send SL-RSRP in dedicated PSFCH resource(s) for the feedback message for PSCCH/PSSCH power control.

For groupcast, the first UE(s) can also send feedback with dedicated (separate) PSFCH resource(s) for each first UE. However, shared PSFCH resource(s) can also be used for the groupcast feedback of first UEs, e.g., to reduce number of resource for the feedback of first UEs. In this case, multiple first UEs may share PSFCH (communication) resource(s) for the groupcast feedback.

For example, for HARQ feedback, multiple first UEs can be configured to send NACK feedback message on a shared PSFCH communication resource. For this feedback, the first UEs can also be grouped according to a first UE's SL-RSRP and/or Tx-Rx distance, such that first UEs with a SL-RSRP and/or Tx-Rx distance within a range of SL-RSRPs and/or Tx-Rx distances, respectively, share a PSFCH communication resource. The Tx-Rx distance may refer to the (relative) geographical distance between the second UE and the first UE. The Tx-Rx distance can be determined based on the location of the second UE and the location of the first UE. The Tx-Rx distance can also be determined based on the zone ID associated with the second UE's location and the zone ID associated with the first UE's location, wherein the zone may be (pre)configured with respect to a geographical area.

For HARQ feedback, for example, first UEs with a Tx-Rx distance within a Tx-Rx distance range can be configured to send NACK feedback on a shared PSFCH communication resource associated with that Tx-Rx distance range. In particular, first UEs with a Tx-Rx distance less than or equal a Tx-Rx distance threshold, e.g. the communication range requirement, may be configured to send NACK feedback on a shared PSFCH communication resource. The SL-RSRP may refer to the SL reference signal received power at the first UE of a reference signal transmitted by the second UE.

The first UEs can also be configured to share PSFCH communication resource(s) for other type of groupcast feedback (messages), e.g. for the SL-RSRP report for PSCCH/PSSCH power control. Similar to HARQ feedback, multiple first UEs can be configured to send feedback messages for power control on a shared PSFCH resource. As for HARQ feedback messages, the first UEs can also be grouped according to a first UE's SL-RSRP and/or Tx-Rx distance, such that first UEs with a SL-RSRP and/or Tx-Rx distance within a range of SL-RSRPs and/or Tx-Rx distances, respectively, share a PSFCH communication resource for the SL-RSRP report.

Other criteria, besides Tx-Rx distance, or SL-RSRP, or combination of both, may be considered for grouping the feedback messages of the first UEs, or for determining when a first UE sends a feedback message on a shared PSFCH communication resource, e.g. a Tx UE sends a feedback message on a certain PSFCH communication resource, if the Tx-Rx distance lies within a certain Tx-Rx distance range, and/or if its SL-RSRP is above a determined threshold.

Thus, for groupcast feedback, shared PSFCH communication resource(s) can be associated with a SL-RSRP and/or Tx-Rx distance range.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows unicast and groupcast transmissions and feedback.

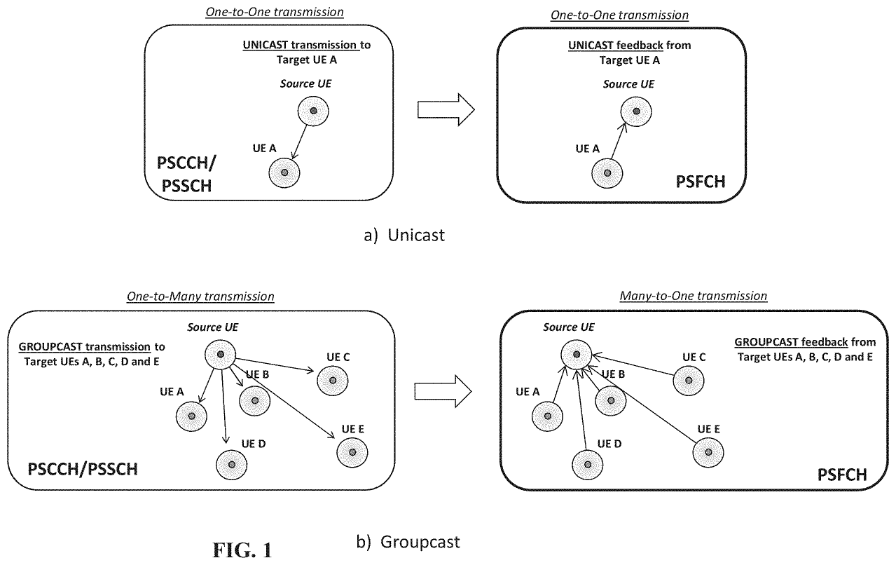

FIG. 2 shows a feedback to a unicast transmission.

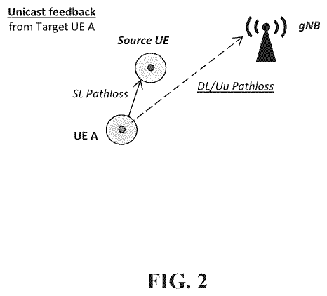

FIG. 3 shows a feedback for a groupcast transmission.

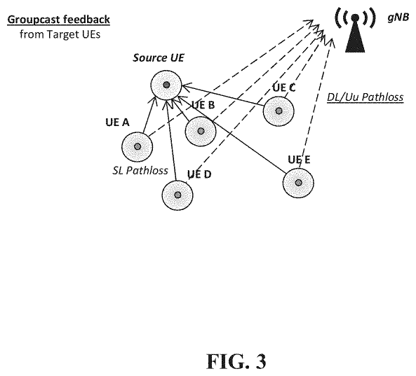

FIG. 4 shows a first UE and a second UE according to embodiments of the invention.

FIG. 5 shows an example PSFCH power control configuration per communication resource.

FIG. 6 shows an example of PSFCH power control adapted to interference.

FIG. 7 shows an example of a PSFCH power control configuration.

FIG. 8 shows an example of a PSFCH power control configuration.

FIG. 9 shows an example of a PSFCH power control configuration depending on the ACK or NACK feedback.

FIG. 10 shows method for performing power control for SL feedback according to an embodiment of the invention.

FIG. 11 shows an example of a PSFCH power control depending on a communication resource

FIG. 12 shows an example of a PSFCH power control configuration depending on a HARQ feedback.

FIG. 13 shows an example of a PSFCH power control configuration depending on feedback type and/or content.

FIG. 14 shows an example of an updated PSFCH power control configuration in a groupcast way.

FIG. 15 shows an example of different Considerations for PSFCH power control depending on a communication resource.

FIG. 16 shows an example of PSFCH power control parameters determined at the first UE.

### DETAILED DESCRIPTION OF EMBODIMENTS

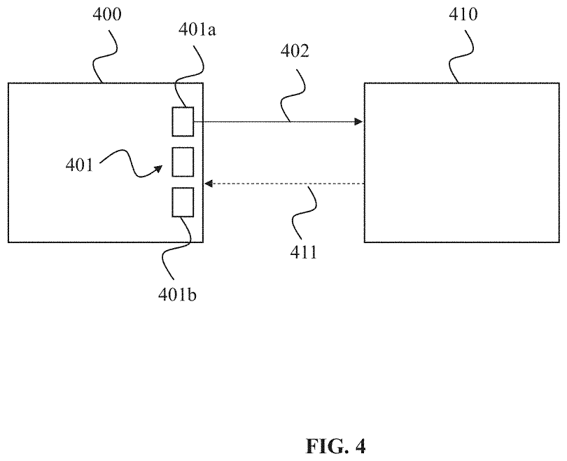

FIG. 4 shows a first UE 400 (in the following also the “Target UE 400”) and a second UE 410 (in the following also the “Source UE 410”) according to embodiments of the invention. The first UE 400 is configured to perform power control for SL feedback, and/or the second UE 410 is configured to support a power control for SL feedback.

The first UE 400 is configured to select a (certain) communication resource 401a for sending a feedback message 402 over a SL to the second UE 410. The first UE 400 may select this communication resource 401a from a plurality of resources 401 or set of resources 401 (resource set). Further, the first UE 400 is configured to select a power level for sending the feedback massage 402, wherein the power level is selected based on the selected communication resource 401a. In addition, the power level may be selected based on a type and/or a content of the feedback message 402. The first UE 400 may then be configured to send the feedback message 402 to the second UE 410 on the selected communication resource 401a according to the selected power level.

The second UE 410 may thus be configured to receive the feedback message 402 from the first UE 400. Further, the second UE 410 can be configured to provide a configuration message 411 to the first UE 400 (e.g., before the first UE 400 sends a feedback message 402), wherein the configuration message 411 indicates at least one association between a communication resource 401a, e.g. between the selected communication resource 401a and/or one or more unselected communication resources 401b, of the resource set 401, and a power control configuration. The first UE 400 may receive the configuration message 411, and may select the power level based on the selected communication resource 401a according to the power control configuration, which is associated with that communication resource 401a. However, this is optional, and the first UE 400 does not need the configuration message 411 to select the power level (thus the configuration message 411 is illustrated with a dashed line in FIG. 4). The at least one association between a communication resource 401a, e.g. between the selected communication resource 401a and/or one or more unselected communication resources 401b, of the resource set 401, and a power control configuration can also be preconfigured.

The first UE 400 and/or the second UE 410 may each comprise a processor or processing circuitry (not shown) configured to perform, conduct or initiate the various operations of the first UE 400 and/or second UE 410 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors.

The first UE 400 and/or second UE 410 may further each comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the first UE 400 and/or second UE 410 to be performed.

In one embodiment, the processing circuitry comprises one or more processors and a non-transitory memory connected to the one or more processors. The non-transitory memory may carry executable program code which, when executed by the one or more processors, causes the first UE 400 and/or second UE 410 to perform, conduct or initiate the operations or methods described herein.

The content of the PSFCH power control configuration message 411 or a preconfigured PSFCH power control configuration which is associated with a communication resource 401a may include the information, whether the PSFCH power control is based on the DL pathloss and/or on the SL pathloss. Further, the information, whether it is based on any other pathloss, e.g. it could be based on a pathloss from the Target UE 400 to one or more other UE(s), or it could be based on a pathloss from the Target UE 400 to one or more gNBs. In addition, the content of the PSFCH power control configuration message 411 may include information on one or more of the following exemplary parameters for performing the PSFCH power control:
A maximum transmit power P_{MAX}.
A nominal power P₀, for each of the pathloss(es), on which the PSFCH power control is based.
A factor α (i.e. parameter used for fractional power control), for each of the pathloss(es), on which the PSFCH power control is based.
A fixed transmit power P_{Fixed} to be used by the first UE 400, i.e. if it does not exceed the maximum transmit power.

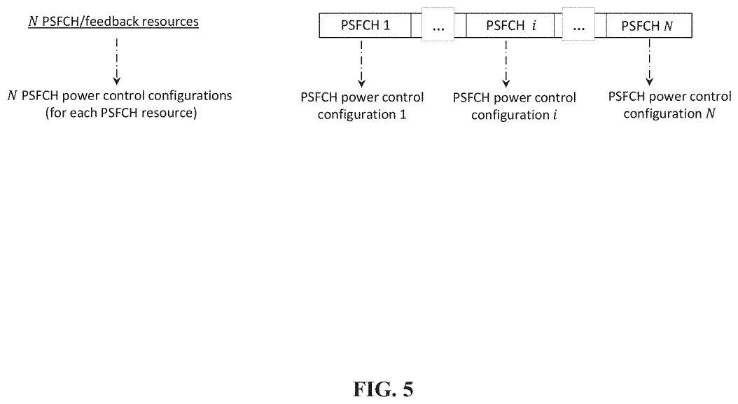

In contrast to configuring the PSFCH power control for each of multiple Target UEs 400 individually, the PSFCH power control can be configured per PSFCH communication resources, as it is illustrated in FIG. 5. In addition, the PSFCH power control may also be based on the content of the feedback message 402 and/or feedback type.

Configuring the PSFCH power control in dependence of the PSFCH resource, may have the advantage that the PSFCH power control (configuration) for each PSFCH resource may be determined by the Source UE 410. For instance, the Source UE 410 can signal the power control configuration message 411 with the indication/determination of the PSFCH resources or as a part of control information to the Target UE(s) 400. The PSFCH power control (configuration) per feedback communication resource may alternatively be (pre)configured at the Target UE(s) 400, or it may be signaled in a groupcast way, to a group of Target UEs 400, instead of configuring each Target UE 400 separately, i.e. instead of signaling the power control configuration message 411 (including power control parameters) to each Target UE 400 separately.

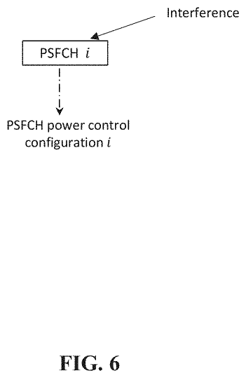

Furthermore, the Source UE 410, as a receiver of the SL feedback message 402, may be aware of interference on a given PSFCH communication resource, and thereby may adapt the PSFCH power control depending on the interference on that PSFCH communication resource, as it is shown in FIG. 6.

Thus, the Source UE 410 may update the PSFCH power control configuration on a certain PSFCH communication resource depending on determined interference, and may afterwards signal the updated PSFCH power control configuration via a configuration update message to the Target UE(s) 400. As the interference can result from a neighboring PSFCH communication resource, the Source UE 410 may also adapt the PSFCH control configuration of that PSFCH communication resource, e.g., to reduce the transmit power, and in turn reduce the interference that this PSFCH communication resource may cause on another PSFCH communication resource.

In addition, for groupcast feedback over shared communication resources, the PSFCH power control configuration for each PSFCH shared communication resource may be determined, instead of configuring separately a dedicated PSFCH power control for each of the Target UEs 400 that perform the feedback (send the feedback message 402) over the shared communication resources. In particular, this is of an advantage, when the number of Target UEs 400 is large (e.g., when the number is larger than the available number of PSFCH communication resources), or when the number of Target UEs 400 is unknown, or when the group/number of Target UEs 400 for groupcast transmission is not known (e.g., connectionless groupcast transmission), because signaling PSFCH power control parameters to each Target UE 400, or configuring the PSFCH power control for each Target UE 400, separately, can be avoided.

Target UEs 400 sharing one or more PSFCH resources may use the same PSFCH. However, this does not necessarily mean that the Target UE(s) 400 sharing the one or more PSFCH communication resources would have to send their feedback messages 402 with the same transmit power, as this may depend on specific parameters of each Target UE 400, e.g. on the DL pathloss to each Target UE 400, which may be distinct.

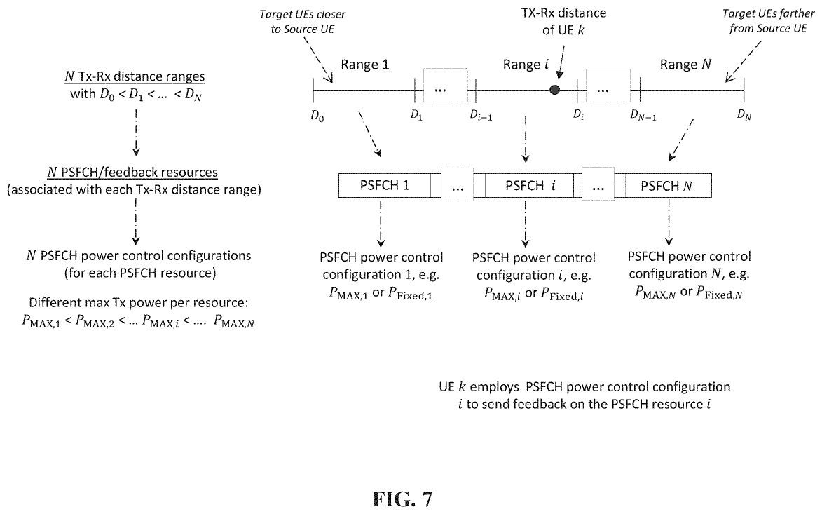

Furthermore, the Target UEs 400 could be grouped for their feedback messages 402, e.g., according to criteria like Tx-Rx distance (their distance to the Source UE 410) or SL-RSRP. That is, a shared PSFCH resource may be associated with a range of Tx-Rx distances, or SL-RSRPs, and Target UEs sending feedback messages 402 on a shared PSFCH resource may have a Tx-Rx distance or SL-RSRP within a certain range of Tx-Rx distances or SL-RSRPs. This can offer the advantage that the PSFCH power control of the Target UEs 400, which send feedback messages 402 on a shared PSFCH communication resource, can be configured depending on the range of Tx-Rx distances, SL-RSRPs, or any other criteria that is used to group the Target UEs 400, wherein the range is associated with the PSFCH resource. This is shown in FIG. 7.

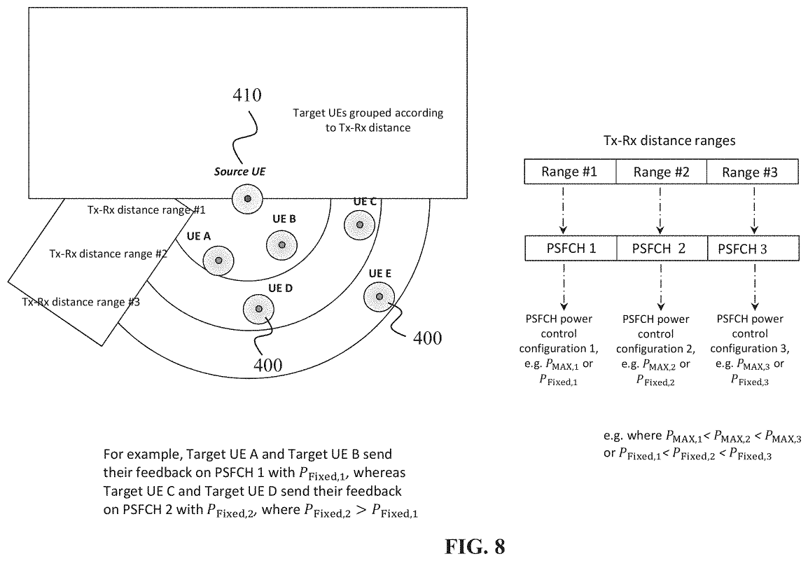

Notably, the Source UE 410 may be aware of how the Target UE(s) 400 are grouped for the groupcast feedback over shared communication resources. In particular, when considering several shared PSFCH resources, each one being associated with a different range of Tx-Rx distances (e.g. ranges 1 to N shown in FIG. 7) or SL-RSRPs (not depicted in FIG. 6), the SL pathloss of the Target UEs 400 may be compensated, for example, by configuring a different fixed transmit power P_{Fixed} for the feedback on each shared PFSCH resource, wherein the fixed transmit power depends on the range of Tx-Rx distances or SL-RSRPs associated with the PSFCH resource. For instance, the maximum transmit power or a fixed transmit power for each feedback resource may be configured such that a higher Tx power is set on feedback resources associated with ranges with lower SL-RSRP or larger Tx-Rx distances, whereas lower Tx power may be configured on feedback resources associated with ranges of higher SL-RSRP or smaller Tx-Rx distances, as depicted in FIG. 8.

The power control configuration may enable compensating, at least to some extent, for the SL pathloss of the Target UE(s) 400, without the Target UE(s) 400 requiring to determine or to obtain the SL pathloss, i.e., without applying SL pathloss based PSFCH power control, while still obtaining benefits of a SL based pathloss PSFCH power control. The PSFCH power control can be configured for each communication resource, i.e. depending on its associated range. When multiple Target UEs 400 are grouped, as described above, the SL pathloss could also be derived based on the Tx-Rx distance and/or SL-RSRP range of the given Target UE 400.

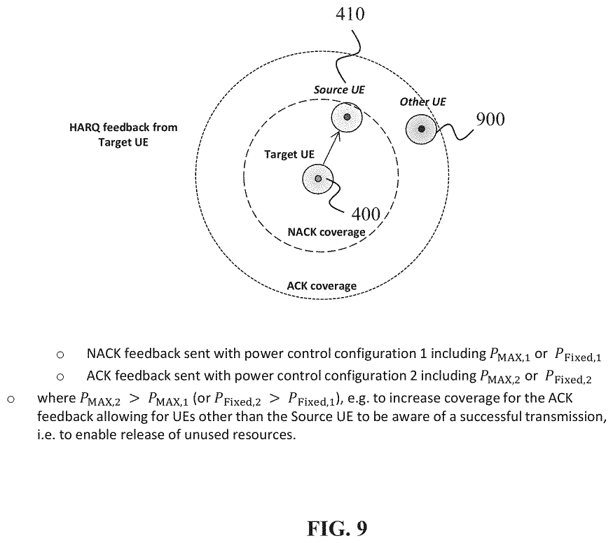

Configuring the PSFCH power control depending on the content and/or type of feedback message 402 can have the advantage that other UEs 900, besides the Source UE 410, could receive or overhear selected content and/or certain types of feedback. For example, it may be beneficial for other, nearby, UEs 900 to receive any ACK feedback of a unicast transmission, in order to support release of unused resource(s), in case of resource reservation based retransmissions for mode 2. On the other hand, it may not be necessary for other, nearby, UEs 900 to receive NACK feedback, and hence, it may be advantageous that the power control configuration for sending the ACK and for sending NACK is different. For example, ACK may be sent with a higher maximum transmit power or a higher fixed transmit power, whereas NACK may be sent with a lower maximum transmit power or a lower fixed transmit power—as is depicted in FIG. 9. The PSFCH power control configuration may also depend on the type of feedback, as for example other UEs 900 nearby may not be interested in receiving feedback for PSCCH/PSSCH power control, i.e. it would only result in interference.

Another advantage can be that for out-of-coverage scenarios, when the PSFCH power control is not based on the SL pathloss, this may result in the Target UEs 400, e.g., for feedback of a groupcast transmission, to send the feedback message 402 at a maximum transmit power, which may cause unnecessary interference or energy consumption at a Target UE. If the Target UEs 400 are grouped based on a Tx-Rx distance or SL-RSRP, the Target UEs 400 may be configured to transmit at a lower power, similarly as detailed above.

Further, flexible configuration for PSFCH power control is enabled, depending on the communication resource, feedback message content, and/or feedback message type. The power control is applicable to unicast, groupcast, and/or groupcast feedback messages 402. Further, the power control is suitable for in-coverage and/or out-of-coverage, and/or for PSFCH power control based on DL pathloss and/or SL pathloss.

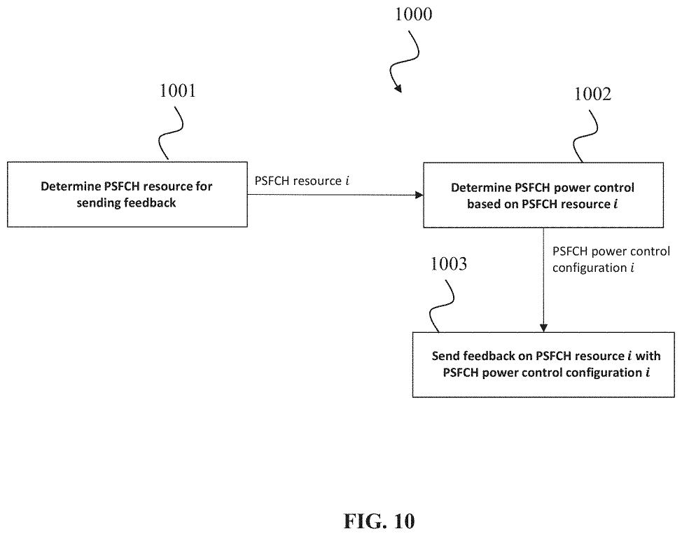

FIG. 10 shows a method 1000 according to an embodiment of the invention, wherein the PSFCH power control for sending 1003 the feedback message 402 on the PSFCH resource i is determined based on the PSFCH power control (configuration) associated with that PSFCH resource i. The PSFCH resource 401a for sending 1003 the feedback message 402 may be determined or selected 1001 from a plurality or set of resources 401, for example, assigned by the Source UE 410 or by the network (e.g. for a dedicated feedback). The resource 401a may also be selected 1001, e.g., depending on the Tx-Rx distance, SL-RSRP or SL pathloss of a Target UE 400, e.g., for groupcast feedback over shared communication resources. The PSFCH power control is then selected 1002 based on the selected communication resource 401a.

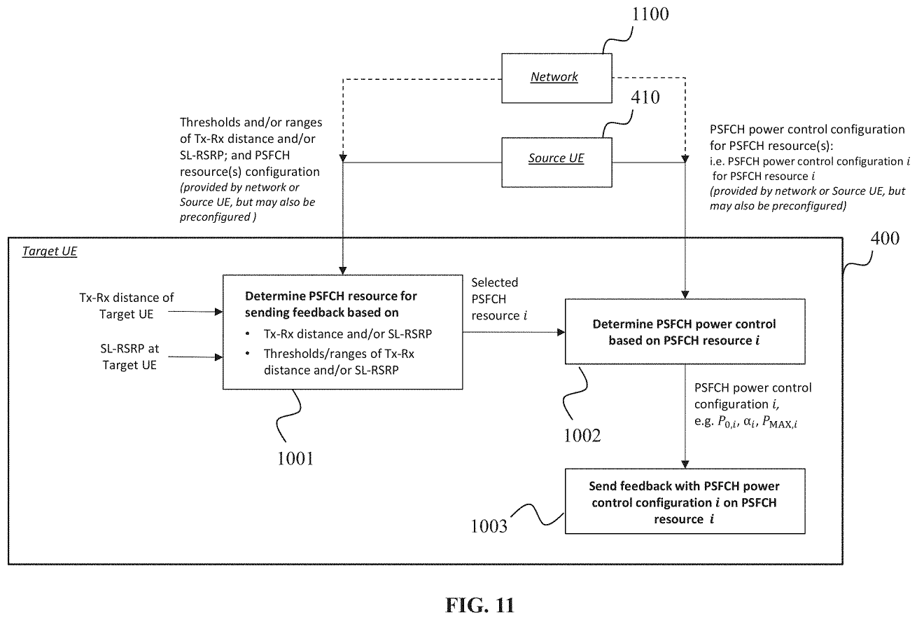

FIG. 11 depicts a flowchart, wherein the PSFCH power control (performed by the Target UE 400) is based on PSFCH resources 401 (resource set), which are associated with ranges and/or thresholds of the Tx-Rx distance and/or SL-RSRP, e.g. for groupcast feedback over shared PSFCH communication resources 401. The PSFCH power control configuration(s) for the PSFCH resource(s) 401 may be provided by the network or the source UE 410. The PSFCH power control configuration(s) for the PSFCH resource(s) 401 may also be preconfigured. The ranges and/or thresholds of the Tx-Rx distance and/or SL-RSRP for enabling a Target UE 400 to determine and select 1001, which PSFCH resource 401a to use for its feedback message 402, may be provided by the network or the Source UE 410. After the Target UE 400 has determined the PSFCH resource 401a, it may then determine 1002 the PSFCH power control for that PSFCH resource 401a, and may send 1003 the feedback message 402 with that PSFCH power control.

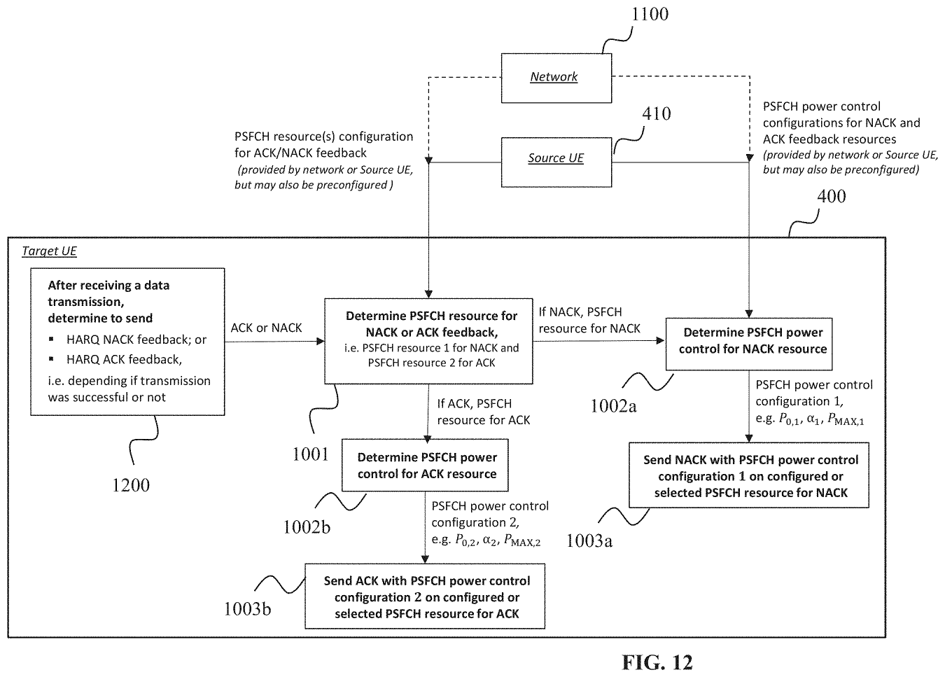

FIG. 12 depicts a flowchart, wherein the PSFCH power control (performed by the Target UE 400) is based on HARQ feedback. The PSFCH power control configuration for sending 1003a NACK and the PSFCH power control for sending 1003b ACK may be provided to the Target UE 400 by the network or the source UE 410. The PSFCH power control configuration for sending NACK and the PSFCH power control configuration for sending 1003a ACK could also be preconfigured. Based on whether a transmission was successful or not, a Target UE 400 may determine 1200, whether to send ACK or NACK, and based on selecting 1001 the ACK or NACK communication resource, it may decide 1002a/1002b which PSFCH power control configuration to use for the ACK or NACK feedback message 402.

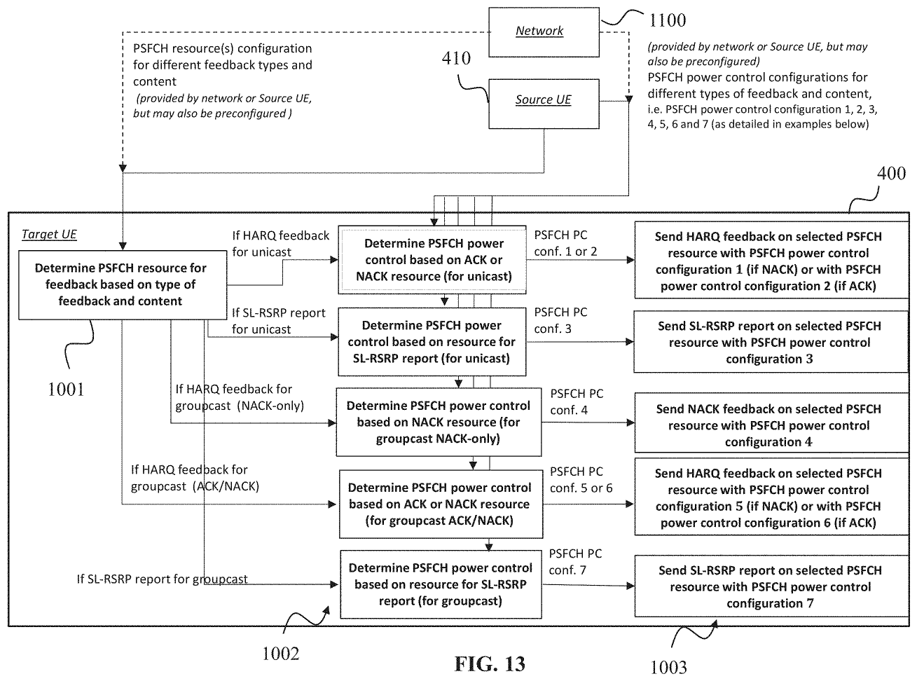

FIG. 13 shows a flowchart, wherein the network or Source UE 410 configures the PSFCH power control for a Target UE 400, depending on the feedback message type and/or content. The PSFCH power control configurations depending on the feedback message type and/or content could also be preconfigured. The Target UE 400 may determine 1001 the PSFCH resource 401a based on the type and content of the feedback message 402. Based on the PSFCH power control configuration, the Target UE 400 may determine 1002 the PSFCH power control depending on the type of the feedback message 402 and/or on the content of the feedback message 402, and based on the determined PSFCH resource 401a. For example, the Target UE 400 may determine 1002 the PSFCH power control depending on whether it is sending 1003 a HARQ feedback message 402 for unicast or for groupcast, or depending on whether it is sending 1003 ACK, NACK, or NACK-only feedback, or depending on whether it is sending information about the SL-RSRP for PSCCH/PSSCH power control for unicast or groupcast as feedback message 402, i.e. SL-RSRP report for unicast or groupcast. PSFCH PC conf. stands for PSFCH power control configuration.

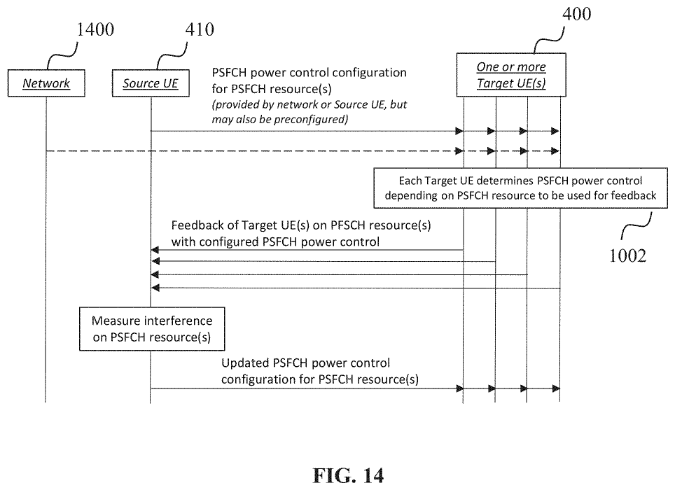

FIG. 14 shows a signaling chart, wherein the PSFCH power control configuration(s) for the PSFCH resource(s) 401 is signaled by the network 1400 or by the Source UE 410 to Target UE(s) 400 in a groupcast way. The PSFCH power control configuration(s) for the PSFCH resource(s) 401 may be provided by the network 1400 or source UE 410. The PSFCH power control configuration(s) for the PSFCH resource(s) could also be preconfigured. Afterwards, the Target UE(s) 400 may determine 1002 the PSFCH power control depending on the PSFCH resource 401a that the Target UE 400 will use for the feedback message 402. The Target UE(s) 400 then sends the feedback message 402 with the configured PSFCH power control. The Source UE 410 may measure the interference on the PSFCH resource(s) 401a and based on the measurements it can update the PSFCH power control configuration for the PSFCH resources 401. For example, if a PSFCH resource 401a experiences high interference, the Source UE 410 can update (in a groupcast way) accordingly the PSFCH power control configuration, i.e. the PSFCH power control parameters, for that PSFCH resource 401a, e.g. Target UE(s) 400 sending feedback message 402 on that PSFCH resource 401a employs a higher maximum (or fixed) transmit power. In another example, the Source UE 410 can update (in a groupcast way) the PSFCH power control configuration for PSFCH resources 401, which cause high interference, e.g. to other PSFCH resources 401, such that the PSFCH power control parameters for the PSFCH resources 401 are updated accordingly, e.g. Target UE(s) 400 sending the feedback message 402 on that PSFCH resource 401a employ a lower maximum (or fixed) transmit power

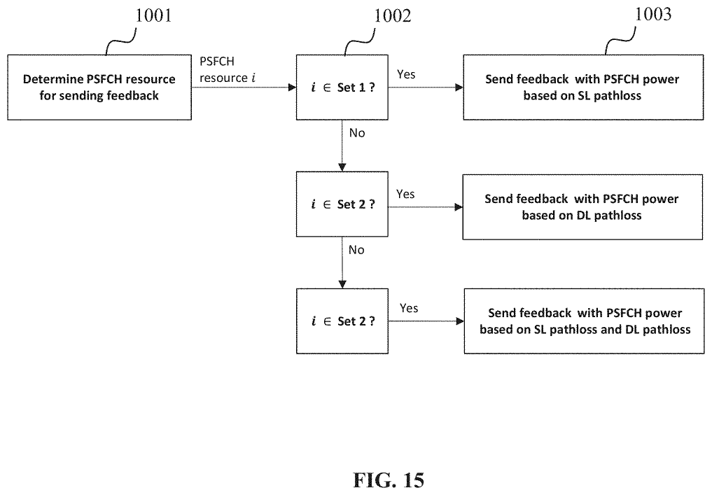

FIG. 15 shows a flowchart, wherein the PSFCH power control in some PSFCH resources 401 are based only on the SL pathloss (set 1), in other PSFCH resources 401 it is based only on the DL pathloss (set 2), and in other PSFCH resources 401 it is based on the SL pathloss and the DL pathloss (set 3). The different sets of PSFCH resources 401 can be configured by the network 1400, by the Source UE 410 or could be preconfigured. The different sets could also be based on the Tx-Rx distance and/or SL-RSRP. The figure may also be extended to consider other sets of resources 401, when the PSFCH power control can be based on other pathloss(es), e.g. the pathloss to other UEs 900 or the pathloss to other gNBs.

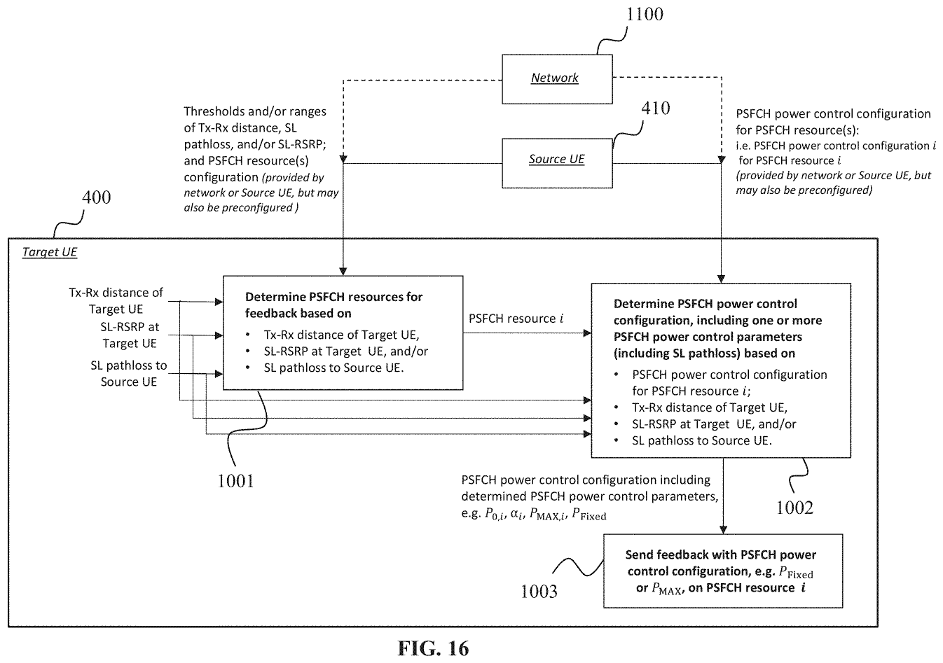

FIG. 16 shows a flowchart, wherein a Target UE 400 determines 1001 a PSFCH resource 401a for the feedback message 402, e.g., based on the Tx-Rx distance, SL-RSRP and/or SL pathloss, and afterwards the Target UE 400 may determine 1002 one or more PSFCH power control parameters, i.e. P_{MAX} or P_{Fixed}, based on the Tx-Rx distance, SL-RSRP or SL pathloss, as well as on a PSFCH power control configuration for that PSFCH resource 401a, which is provided by the network 1400 or Source UE 410, or can be preconfigured. The Target UE 400 determining one or more PSFCH power control parameters provides the advantage that the Target UE 400 can determine a more precise transmit power to compensate for the propagation conditions to the Source UE 410, i.e. to compensate more precisely for the SL pathloss. The Target UE 400 then sends 1003 the feedback message 402 with the configured PSFCH power control for that PSFCH resource 401a and the one or more determined PSFCH power control parameters. This proposed embodiment may be combined with the PSFCH resources 401 being associated to Tx-Rx distance and/or SL-RSRP. In addition, this embodiment also allows for a Target UE 400 to basically consider a finer granularity of Tx-Rx distance and/or SL-RSRP ranges for the determination 1002 of the PSFCH power control parameters. In case of SL pathloss based PSFCH power control, the SL pathloss, as parameter of the PSFCH power control, can be determined based on the Tx-Rx distance and/or SL-RSRP.

The present invention has been described in conjunction with various embodiments as examples as well as implementations. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A first user equipment (UE) configured to perform power control for a sidelink (SL) feedback, the first UE being configured to:
select a communication resource for sending a feedback message over a SL to a second UE; and
select a power level for sending the feedback message, wherein the power level is selected based on the communication resource.

2. The first UE according to claim 1, wherein the first UE is further configured to:
select the power level based further on at least one of a type of the feedback message or a content of the feedback message.

3. The first UE according to claim 2, wherein the type of the feedback message comprises at least one of:
a Hybrid Automatic Repeat Request (HARQ) feedback;
a Reference Signal Received Power (RSRP) report; or
a Channel State Information (CSI) report.

4. The first UE according to claim 2, wherein the content of the feedback message comprises at least one of:
an acknowledgment (ACK) feedback;
a negative acknowledgment (NACK) feedback;
a NACK-only feedback;
a feedback for Physical Sidelink Control Channel (PSCCH); or
a feedback for Physical Sidelink Shared Channel (PSSCH).

5. The first UE according to claim 1, wherein the first UE is further configured to:
select the power level based further on one or more path losses, wherein the one or more path losses comprise at least one of:
a SL path loss between the first UE and the second UE;
a Downlink (DL) path loss between the first UE and a base station configured to serve the first UE;
a path loss between the first UE and a third UE; or
a path loss between the first UE and another base station.

6. The first UE according to claim 1, wherein the first UE is further configured to:
determine the power level based on whether the feedback message is configured for unicast feedback or groupcast feedback.

7. The first UE according to claim 1, wherein the first UE is further configured to:
select the communication resource from a resource set.

8. The first UE according to claim 7, wherein
the resource set is assigned to the first UE by the second UE or by a base station configured to serve the first UE.

9. The first UE according to claim 1, wherein the first UE is further configured to select the communication resource based on at least one of:
a distance between the first UE and the second UE;
a SL path loss between the first UE and the second UE;
a Reference Signal Received Power (RSRP) at the first UE;
an identifier of the first UE; or
an identifier of the second UE.

10. The first UE according to claim 1, wherein the first UE is further configured to:
receive a configuration message or a configuration update message,
wherein the configuration message or the configuration update message indicates at least one association between a communication resource and a power control configuration.

11. The first UE according to claim 1, wherein the first UE is further configured to select the power level based on at least one of the following:
a maximum power level;
a fixed power level;
one or more nominal power levels, each nominal power level of the one or more nominal power levels being associated with a first path loss useable by the first UE to select the power level; or
one or more factors useable for fractional power control, each factor of the one or more factors being associated with a second path loss useable by the first UE to select the power level.

12. The first UE according to claim 1, wherein the communication resource comprises at least one of:
a time resource,
a frequency resource,
a spatial resource, or
a code resource.

13. A second user equipment (UE) configured to perform power control for a sidelink (SL) feedback, the second UE being configured to:
send a configuration message to a first UE,
wherein the configuration message indicates at least one association between a communication resource and a power control configuration.

14. The second UE according to claim 13, wherein the second UE is further configured to:
receive a feedback message on a communication resource from the first UE;
determine an interference at the second UE on the communication resource; and
provide, based on the determined interference, a configuration update message to the first UE,
wherein the configuration update message indicates at least one updated association between the communication resource and the power control configuration.

15. The second UE according to claim 13, wherein the second UE is further configured to:
send at least one of the configuration message or the configuration update message as groupcast message to a plurality of first UEs.
